(19) United States
(12) Patent Application Publication
(10) Pub. No.: US 2012/0047108 A1
(43) Pub. Date: Feb. 23, 2012

(54) POINT-IN-TIME (PIT) BASED THIN RECLAMATION SUPPORT FOR SYSTEMS WITH A STORAGE USAGE MAP API

(76) Inventors: RON MANDEL, Haifa (IL); Roee Engelberg, Tel Aviv (IL)

(21) Appl. No.: 12/860,987

(22) Filed: Aug. 23, 2010

(51) Int. Cl. G06F 17/00

(52) U.S. Cl. 707/639; 707/E17.005

(57) ABSTRACT

A method, a system and/or and an apparatus to minimize data loss by de-allocating storage space with the help of an Application Programming Interface (API). In one embodiment, the method includes reclaiming data storage in a storage device slated as a reclamation target by redirecting write commands intended for the reclamation target to a point-in-time volume of the reclamation target; generating a list of portions of storage from the reclamation target such that each portion of storage has an API state of unused as per a system that uses the storage device; and includes converting a reclamation state associated with each of the portions of storage to a state of ‘unused’. In addition, the method involves synchronization of the point-in-time volume with the reclamation target to capture any changes that might be associated with the point-in-time volume.

### FIELD OF TECHNOLOGY

Embodiments of the disclosure relate generally to a field of storage devices and in one embodiment to a method, system or an apparatus of a Point in Time (PiT) based thin reclamation of a thin volume of storage.

### BACKGROUND

A thin provisioning system can allocate portions of storage which can also be referred to as chunks or blocks of storage, on a data storage device to one or more storage utilization applications. If a storage utilization application does not utilize some of the allocated portions of storage, and if the data storage device and the storage utilization application do not have an ability to reclaim those unused portions of storage, then the data storage device is not being utilized to its full potential. Furthermore the data storage device often provides storage services to multiple storage utilization applications, e.g. by exposing different volumes to the different storage utilization applications. If the different storage utilization applications have allocated significant numbers of portions of storage that are unused, then the cumulative amount of allocated but unused storage may be substantial, and the available storage in a data storage device may be seriously decreased, miscalculated or misrepresented.

A file system application designed ab initio for synchronization and thin reclamation of a thin volume typically does not have the problem of allocated portions of storage that are unused. However, there are both current and older file systems that do not support thin reclamation at all, or that do not do so in an efficient manner. Consequently, the performance of the data storage device on these systems can be compromised.

While some of legacy file systems may have an Application Programming Interface (API) that can retrieve a usage map of the storage device, thus indicating the state of each portion of storage as “used” or “unused,” the states can be state by the time the usage map is returned. That is, during the time the API is gathering the states of the portions of storage, the storage utilization application itself may have gone back to some of the portions of storage gathered early on by the API and changed their states, e.g., from an “unused” state to a “used” state. If so, then the state in the usage table of those portions of storage whose state was later changed, e.g., typically by the storage utilization application, is now obsolete. If reclamation is then based on the usage table, this would most likely result in a loss of data for the application, which is naturally unacceptable.

### SUMMARY

Disclosed are a method, a system and/or an apparatus for Point in Time (PiT) based thin reclamation support for file systems without built-in thin reclamation and without synchronization capabilities that would otherwise avoid loss of data.

In one aspect, a method reclaims data storage in a data storage device slated as a reclamation target by creating a PiT volume and redirecting write commands intended for the reclamation target located on the storage device to the PiT volume of the reclamation target. Also, the method includes generating a list of one or more portions of storage from the reclamation target that each has an API state of “unused” per a system, e.g., a file system, that uses the storage device to store data. Next, the method includes converting the state associated with each portion of storage from the list to an “unused” state and synchronizing the PiT volume to the reclamation target to capture any changes in the PiT volume arising during the previous steps. Thus, two possible states of “used” and “unused” exist for the portions of storage being managed.

Additionally, the method includes communicating the list of one or more unused portions of storage to the storage device, which is the reclamation target. The storage device, now the reclamation target, maintains a state of each portion of storage, which state is referred to as the reclamation state. Then the method includes maintaining the reclamation state of “unused” for a given portion of storage in the list if a respective given portion of storage in the PiT volume does not receive an access command and, conversely, canceling reclamation of a given portion of storage in the reclamation target if an access command was directed to the given portion of storage in the point-in-time volume, e.g., converting the reclamation state of the given portion of storage to “used.” In the latter case, the method would also include copying substantive data from the given portion of storage in the point-in-time volume to a respective portion of storage in the reclamation target. An API state associated with a given portion of storage supersedes a reclamation state of the given portion of storage during the reclamation process.

In an optional embodiment, the method includes maintaining a reclamation state of “unused” for each of the portions of storage in the list if no access command is given to the entire point-in-time volume during the method of reclaiming data storage. The method may also include deleting the point-in-time volume after completing synchronization. However, the method might not require synchronization between the point-in-time volume and the reclamation target if no access command is redirected to the point-in-time volume. The method includes reclaiming data storage of each portion of storage in the reclamation target having a reclamation state of “unused” following synchronization with the data storage device.

Converting the reclamation state of the portion of storage may be performed by the storage device. Also, in one embodiment, converting appears as an atomic operation to a host electronic device utilizing the storage device.

In one embodiment, the reclamation target is a thin volume, while the portion of storage is a chunk of storage, and while the access command is any command to the chunk of storage that might affect its state or its content or substantive data, where such access commands can include a read command, a write command, or either a read or write command. The access command can also be described as an item selected from a group including a read command, a write command, and a read and write command.

The method may be implemented on an any type of device or system that can execute the instructions such as an item selected from a group including a storage device, a host system, a standalone device, and an intermediate switching device, any of which can use any point-in-time protocol. The storage reclaimed may be an item selected from a group including an on-die cache, a local memory, an external storage, a network attached storage, and a remote storage device. Furthermore, the memory may be stored on any kind of medium, whether flash, hard drive, or other type of rewritable memory and may be stored in any temporal status, whether volatile or non-volatile.

A device for performing the reclamation process includes a local memory, a local processor coupled to the local memory and the local processor. The local memory of the device executes instructions for a method of reclaiming data storage in a storage device slated as a reclamation target. The method includes the instructions described hereinabove. Also, the instructions for the method may be stored on a computer readable medium. Thus, in one embodiment, the device is a standalone mobile cell phone that manages local data storage used by one, or multiple concurrent, end-user software applications.

In another aspect, a system for performing the reclamation process includes a storage device, with a local memory coupled to a local processor, and a host electronic device in turn coupled to the storage device. The host electronic device and the storage device may execute instructions for a method of reclaiming data storage in a storage device slated as a reclamation target. The method includes the instructions described hereinabove. Thus, in one embodiment, the system utilizes a storage utilization application on a host computer for performing the reclamation process on one or more data storage devices storing data for end-user software applications running on other application servers, all of which are coupled together in a local area network, or on the Internet.

### BRIEF DESCRIPTION OF THE VIEW OF DRAWINGS

Example embodiments are illustrated by way of example and not limited to the figures of the accompanying drawings, in which references indicate similar elements and in which:

FIG. 1 illustrates a network system for implementing the reclamation process, according to one or more embodiments.

FIG. 2 illustrates a schematic view of an individual device for implementing the reclamation process for local data storage, according to one or more embodiments.

FIGS. 3A, 3B, and 3C illustrate storage usage during different stages in the process of reclaiming data from a reclamation target, according to one or more embodiments.

FIG. 4 illustrates a case table with tabular representation of different possible combinations and permutations of states for portions of storage slated to be reclaimed, according to one or more embodiments.

FIGS. 5A and 5B illustrate a flow chart depicting the various stages of the reclamation process, according to one or more embodiments.

### DETAILED DESCRIPTION

A thin volume is the result of virtualization technology that can reduce storage requirements and ensure smooth operation of the device. A thin volume may be configured as a buffer for storing data, where the storage capacity of the buffer increases when there is a need for greater data storage. The embodiments described herein are directed towards better utilizing existing storage space within a storage device in an efficient manner while guaranteeing no data loss.

A storage utilization application that reserves storage space does not necessarily use all of the reserved storage space, or the storage space may have been used to store data, then released as the data was no longer needed Thus, some of this reserved storage space may be wasted as it cannot be utilized for other storage utilization applications. If a number of storage utilization applications are active over a period of time, there may be an accumulation of wasted storage space that may lead to inefficient use of storage space. A process of reclamation of storage such that unused storage space is reclaimed via a file system API, or some other host system utilizing the storage, is described.

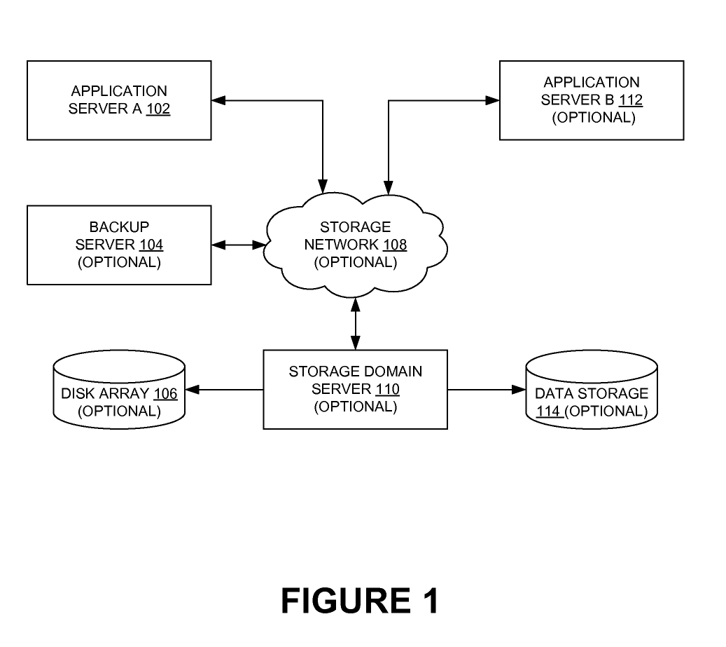

FIG. 1 illustrates a network system for implementing the reclamation process. The network system can include any combination of devices such as an application server A (102) coupled to an optional application server B (112), an optional storage network (108), an optional backup server (104), an optional disk array (106), an optional storage domain server (110), and/or an optional data storage (114). If application server A (102) is hosting one or more end-user software applications that will use storage, then the reclamation target of storage could be located on the optional data storage (114), or in a storage portion on any of the other optional devices. Likewise, the file system API software, and a processor hardware implementing the reclamation process, could be located on the application server A (102) or in some other optional device in the network. There could be multiple devices active that enable a first end-user software application running on application server A (102) with data being saved to application server B (112). In another scenario, there could be a second end-user software application running on Application Server B (112) with data being stored on the data storage device (114), such as but not limited to optical disks, hard disk drives, or even being stored on the disk array (106) such as, but not limited to, modular storage area network arrays, monolithic storage area network arrays and utility storage arrays. Also, included in FIG. 1 is a storage network (108) that could be a Local Area Network (LAN), a Wide Area Network (WAN), a Metro Area network (MAN), or other type of network of any size. Backup server (104) can be any server type and storage domain server (110) can be any type of domain server.

In one embodiment, reclamation of storage from a storage device in, but not limited to, cell phones, servers, computer networks, or other devices using storage is described herein. The storage device could be an item from a group including an on-die cache, a local memory, an external memory, a network attached storage and a remote storage device. The process of reclaiming data storage in a storage device may be implemented on an item selected from a group including a storage device, a host system, an intermediate switching device, a personal computer, a server, and other network computers, where any of the storage devices can use any Point-in-Time protocol.

The API can be an interface between two different software programs. In one or more embodiments, the API could be used for a variety of purposes such as, but not limited to, extending existing storage management software to include additional storage, automatic provisioning of storage and managing storage systems topology.

In one or more embodiments, the API is configured to determine the state of each of a portion of storage, as determined by a system that uses the storage device, or a storage utilization application. A storage utilization application, or system that uses the storage device, refers to a file system or other host system that controls, utilizes, and in general manages data storage, e.g., long term data storage. The storage utilization application is distinguished from an end-user software application, such as a word processing application, a spreadsheet application or a file-based database application, in that the end-user software application must use the storage utilization application in order to interface with the data storage device. Thus, the storage utilization application has its own set of rules for ensuring data integrity and determining when a portion of storage is “unused”. A portion of storage can also be referred to as a block of storage, a chunk of storage, storage block, a slice of storage, or any other label that describes a quantum of storage for data.

A physical volume may be, but is not limited to, a hard disk, a hard disk partition or a Logical Unit Number (LUN) of a storage device, or any other physical or virtual allocation of storage. A LUN may be used to refer to an entire physical disk, or a subset of a larger physical disk or disk volume.

In one protocol, physical volumes are treated as portions, or blocks, of storage called Physical Extents that map on a one-to-one basis with portions of storage that are associated with logical volumes (Logical Extents). Multiple Physical Extents are mapped to one Logical Extent; these Logical Extents may then be brought together as virtual disk partitions called Logical Volumes.

Disk storage of a storage device is managed by classification of different volumes. Each physical volume belongs to a volume group and is divided into physical partitions based on the total capacity of the storage device.

In this case, the reclamation target can be a logical volume or a physical volume while the Point-in-Time (PiT) volume is a logical volume. Each logical extent of the PiT volume is mapped to a certain number of portions of storage which comprise the Physical extents.

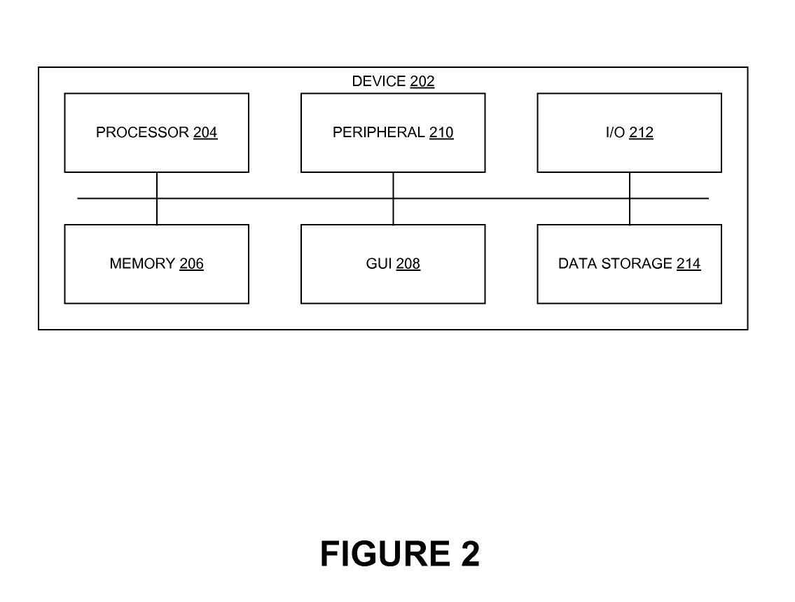

FIG. 2 illustrates a schematic view of an individual device for implementing the reclamation process for local data storage, according to one or more embodiments. FIG. 2 includes a processor (204) coupled to a memory (206) for executing the reclamation protocol on coupled data storage (214). Device (202) includes an input/output (I/O) (212) as well as to optional graphical user interface (GUI) (208) and optional peripheral (210) for additional functionality as known by those skilled in the art. FIG. 2 can illustrate one of the individual devices in FIG. 1, i.e. an application server, backup server, disk arrays or other data storage devices. Alternatively, device (202) can be a standalone device, such as a personal computer, a mobile device, such as a smart phone or global positioning system (GPS), a video game console, or any other device using storage.

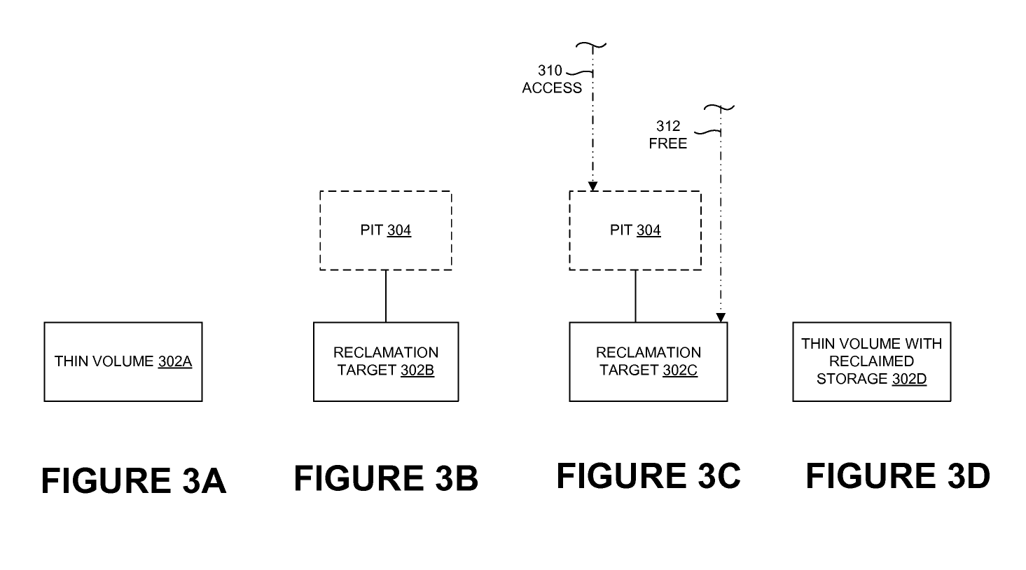

FIGS. 3A, 3B and 3C illustrate storage usage during different stages in the process of reclaiming data from a reclamation target, according to one or more embodiments. FIGS. 3A, 3B, and 3C represent a step wise process flow of reclaiming unused data from the reclamation target of storage device systems that support Redirect-on-write Point-in-Time Volumes (PiTs), or other types or protocols of temporary data storage.

A given storage utilization application can be using a thin volume of storage (302A) in any data storage device, e.g., as shown in FIG. 1 or 2. If that thin volume of storage (302A) is slated as a reclamation target (302B), then a PiT volume (304) copy of the reclamation target is created, as shown in FIG. 3B on any storage device. Access commands (310) such as read and/or write, which were previously sent to the thin volume of storage, are now redirected to the Pit volume (304), as shown in FIG. 3C. If the reclamation process deems a given portion of storage to be unused, then a “free” command (312) is sent to the reclamation target (302C) to change the state of the given portion of storage to “unused,” as shown in FIG. 3C. After the completion of the reclamation process on all portions of data in a reclamation target, the PiT volume (304) is synchronized with the reclamation target (302) to capture any changes to the PiT volume (304) that occurred during the reclamation process. This step will capture any changes in state and any respective changes in substantive data, in the PiT volume (304) and then communicate them to the respective portions of data in the reclamation target (302C), and thus avoid any potential loss of data. Following the synchronization step, the PiT volume is deleted, or released, and thus may not consume storage in the resultant thin volume with reclaimed storage (302D), as shown in FIG. 3D.

The reclamation target (302) and PiT volume (304) could be located in any portion of storage of either data storage (214) in FIG. 2 or data storage (114) of FIG. 1; or in any of the devices in FIG. 1 capable of providing data storage.

In an exemplary scenario for FIGS. 3A, 3B, 3C, and 3D, a thin volume is exposed by a data storage device to be used by a file system followed by an end-user word processing application program needing four portions of storage from the thin volume upon startup. In response, a file server program, or storage utilization application, assigns four portions of storage from the thin volume to meet the end-user program need. Either at that time, or no later than the time the four portions are accessed, e.g. a write IO is sent to them, the data storage device allocates four portions for the file system where the data is stored. Over a period of time some of these portions of storage become redundant as the data stored on them is deleted. The end-user word processing application releases those portions by notifying the file system that they are unused. At this time, the portions are still allocated by the data storage device to the file system, which might have no use for them at that time. The thin reclamation method described herein is then used to identify the set of the portions of storage, allocated for the file system that qualify for reclamation, i.e. are unused by the file system and any of the applications it serves. A point-in-time volume, e.g., a copy, of the portions of storage allocated by the data storage device to the file system is created, the access commands from the end-user word processing application and the file system are redirected to the PiT, and the reclamation process of identifying the states of the portions of storage is performed. Afterwards, the PiT volume and the reclamation target are synchronized, and the portions of storage with a final state of “unused” are deallocated, e.g., freed or released. Next, the PiT volume can be deleted.

This example might be scaled to other storage utilization applications, where possibly each of them serves multiple end-user applications that are running simultaneously. The data storage device exposes one or more volumes to each storage utilization application which requires large amounts of reserved, or allocated, data storage. Without effective thin volume reclamation, the available space in a data storage device may be substantially misrepresented. That is, the available portion of the data storage device that is allocated but unused may represent a substantial portion of the data storage device capacity, and thus may limit the ability of the data storage device to serve additional needs of the storage utilization application(s). However, the present disclosure provides an effective and lossless solution that improves storage utilization and, consequently, system performance.

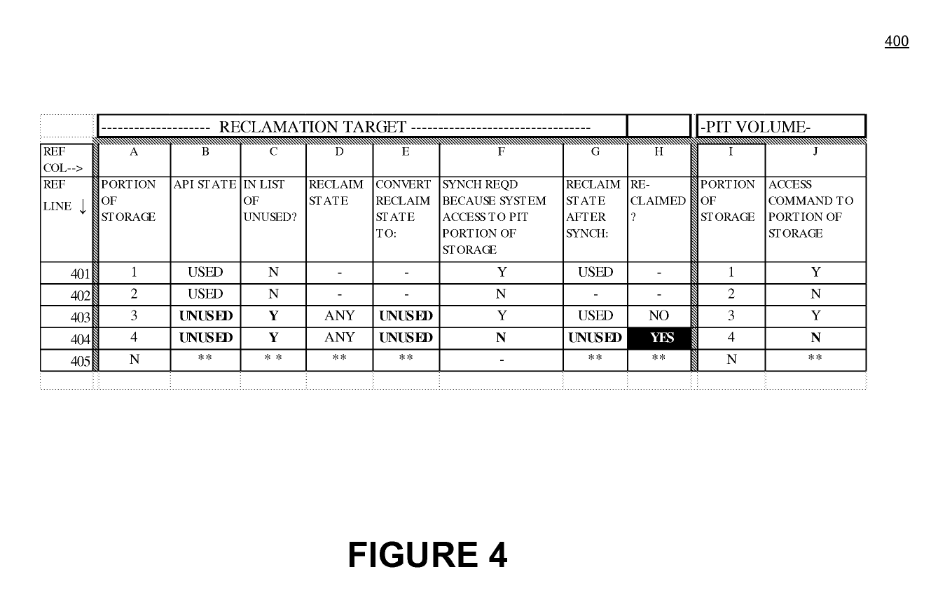

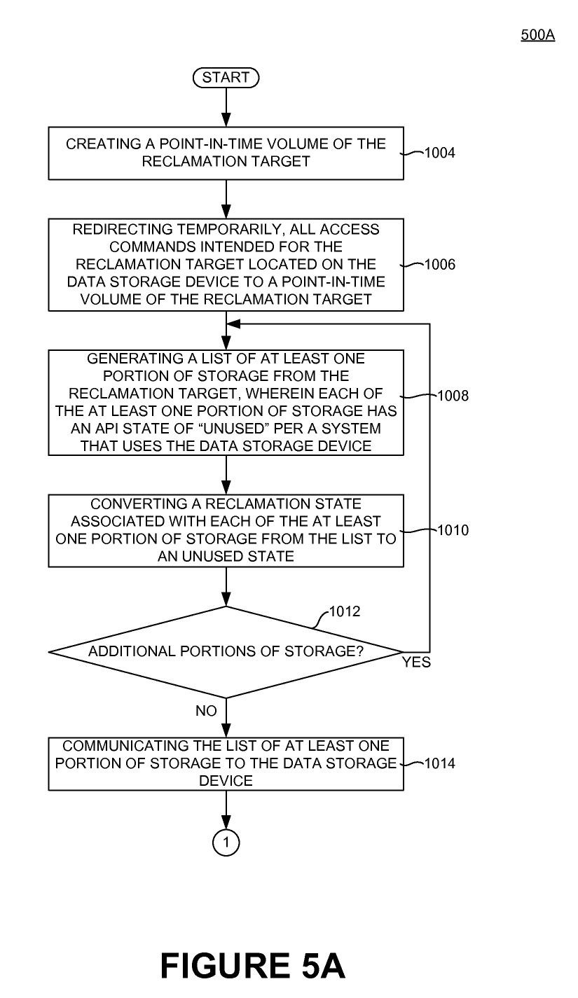

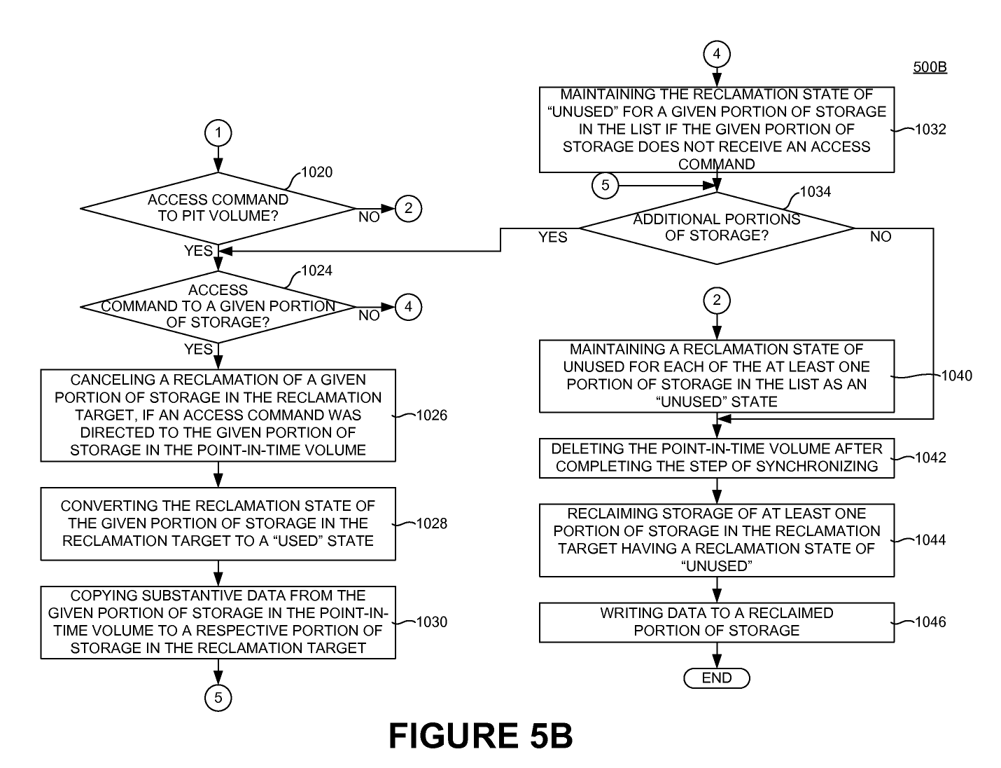

FIG. 4 is a case table with tabular representation of different possible combinations and permutations of states for portions of storage slated to be reclaimed, according to one or more embodiments. In addition, case table (400) provides the subsequent step-wise paths that the portions of storage go through as a part of the reclamation process before being reclaimed. The columnar descriptions for case table (400) will be described immediately hereafter. However, the substantive entries for each case, e.g., each cell in the table, will be described in respective portions of flowcharts 500A and 500B of FIG. 5.

Column A of case table (400) represents four different specific cases of portions of storage, e.g., chunks, in a thin volume on reference lines 401 through 404 with the fifth case line 405 for an unspecified potential future case. Columns B-G relate to the states and the handling of portions of storage in the reclamation target while in parallel, Columns H-J relate to the states and handling of the respective portions of storage in the PiT volume.

Column B is the starting point of the reclamation process in that it lists a storage utilization application's state of either “used” or “unused” for each of the portions of storage per the API. The state of “used” or “unused” for the portion of storage is determined by a system that uses the storage device, e.g., an API that can generate a usage table for each portion of storage allocated by the storage utilization application. Column C indicates whether the portion of storage in the reclamation target is added to a list of ‘unused’ portions of storage, as tabulated by a processor using the present disclosed method. Column D represents the reclamation state associated with each portion of storage. The reclamation state refers to a state of either “used” or “unused” associated with the portion of storage as determined by the viewpoint of the data storage unit, which is now the reclamation target; hence the state is called the reclamation state. If the portion of storage was either read from, or written to, on the actual data storage device, then the reclamation state would be “used,” and if the portion of storage was neither read from nor written to, then the reclamation state would be “unused.” However, the present disclosure is well-suited to other protocols and rules for determining states applicable for different activities and usage of storage. Column E indicates whether the reclamation state will be converted to a different state, per a decision point described hereinafter. Column F indicates whether synchronization is required from the PiT volume to the reclamation target in order to capture any changes that might have occurred in the PiT volume, and thus guarantee the capture of any latest changes to the data and prevent the potential loss of any data. Column G represents the reclamation state of each portion of storage after synchronization is complete. Column H indicates a final result of the reclamation process, e.g., whether a portion of storage was actually reclaimed or not.

Column I is a list of the portions of storage in the PiT volume, which respectively matches the portions of storage in the reclamation target per column A. Column J indicates whether an access command was directed to a given portion of storage in the PiT volume, e.g., during the time period for which access commands are redirected from the reclamation target to the PiT. Column J's access command goes hand in hand with the synchronization requirement of Column F, e.g., if an access command occurred to a portion of storage, then that portion of storage would have to be synchronized from the PiT to the reclamation target. An access command can be any action, as defined by a user or protocol, which affects the content or status of a portion of storage, e.g., a read command, a write command and a read and write command (as an I/O).

FIGS. 5A & 5B illustrate a flow chart depicting the various stages of the reclamation process, according to one or more embodiments. FIGS. 5A and 5B are linked flowcharts 500A and 500B that can be best understood in view of previous figures that illustrate the apparatus, system, and case table.

First step 1004 of the reclaiming data storage method includes creating a Point-in-Time (PiT) volume of the reclamation target. A PiT volume is a copy of the reclamation target, e.g., PiT volume (304) of FIG. 3B, that is created using any system or protocol, such as a redirect-on-write, journaling and copy-on-write, or others. Per table 400 of FIG. 4, the PiT volume includes portions of storage listed in column I, that correspond to portions of storage in the reclamation target listed in column B.

The next step 1006 includes temporarily redirecting all access commands that were intended for the reclamation target to a PiT volume of the reclamation target. For example, as shown in FIG. 3C, step 1006 is implemented by redirecting all access command(s) (310), if any occur, to PiT volume (304). The redirecting of the access command(s) is a temporary process in one embodiment that occurs during the reclamation process, e.g., after the creation of the PiT and before the PiT is deleted. Per table 400 of FIG. 4, an access command to a portion of storage is indicated in column J, with portions of storage 1 and 3 having received an access command in the PiT volume as indicated by a “Y,” for yes, in the table cell.

In the next step 1008, a list is generated of at least one portion, or block, of storage from the reclamation target that has an API state of ‘unused,’ where the API state is determined per the system that uses the data storage device. This step is reflected in column B of table 400 in FIG. 4, where portions of storage 3 and 4 have an API state of “unused,” and thus are included in column C, the list of unused, as indicated by a “Y” in the table cell. Because portions of storage 1 and 2 have an API state of “used” in column B, they do not qualify for reclamation and thus are not considered in subsequent columns D, E, G, and H, though portion of storage 1 has its reclamation state of “used” confirmed because it was accessed during the reclamation process.

Once the API state of the portion of storage has been determined and if that state is “unused,” then the subsequent step 1010 converts the reclamation state associated with each of the portions of storage in the list generated from step 1008 to a state of “unused,” as depicted in Column E of table 400 in FIG. 4. Note that the reclamation state per column D is listed as “any” for portions of storage 3 and 4 because when the API state is determined to be “unused,” it supersedes, or trumps, whatever state exists for the reclamation target, as determined per the data storage device.

Step 1012 inquires whether additional portions of storage exist. If additional portions of storage exist, then the flowchart returns to step 1008 and subsequent steps. If additional portions of storage do not exist then flowchart proceeds to step 1014 where the resultant list generated from step 1008, with at least one portion of storage, is then communicated to the data storage device. As the example of table 400 in FIG. 4 shows, step 1012 will result in the repetition of steps 1008 and 1010 for portions of storage 1 through N, and will result in a list including only portions of storage 3 and 4, having the API state of “unused,” that will be communicated to the storage device of the reclamation target. In another embodiment, step 1010 of converting can occur after the “no” response to inquiry 1012, either prior to or after step 1014 of communicating.

Step 1020 inquires whether any access command was given to the PiT volume during the method of reclaiming data storage. If ‘YES,’ then flowchart proceeds to step 1024. If the result of inquiry 1020 is ‘NO’ then flowchart proceeds to step 1040 thereby skipping steps 1026, 1028, 1030, and 1034 because there were no changes in state or content in the PiT volume that need to be synchronized with the reclamation target. Step 1020 is an optional binary test where a negative response avoids the unnecessary steps of checking each portion of storage for an access command. Thus, because at least one portion of storage in the PiT volume of table 400 in FIG. 4 has received an access command, e.g., either portion of storage 1 or 3, then it is necessary to evaluate all the portions of storage in the PiT volume to confirm which portions of storage need their state and substantive data, or content, synchronized to the reclamation target.

If step 1020 confirmed that there was an access command given to the PiT volume, e.g., a “YES” response, then step 1024 determines which portion of storage received the access command by inquiring whether the access command was given to a given portion of storage, e.g., individually checking all portions of storage in the PiT volume, regardless of whether the portion of storage was included on the list of step 1008 or not. A ‘YES’ response to inquiry 1024 proceeds to serial steps of 1026, 1028, and 1030, while a ‘NO’ response proceeds to step 1032.

Steps 1026 through 1034 proceed as follows. In step 1026, the reclamation of the given portions of storage evaluated from step 1024 will be cancelled, if it was slated for reclamation. In step 1028 the reclamation state of the given portion of storage will be converted to a “used” state regardless of its prior state. And in step 1030 the substantive data from the given portion of storage in the PiT volume is copied to the respective portion of storage in the reclamation target. Together, steps 1026, 1028, and 1030 have the effect of synchronizing the PiT volume with the reclamation target in order to capture any changes that occurred in the PiT volume during the reclamation process. Thus, during synchronization, the PiT volume has the latest data from the end-user application and the latest state and data from the storage utilization application, so as to guarantee no loss of data. The effect of this converting process is that the state of the PiT volume, as updated by an access command, for a given portion of storage, will supersede, or trump, a reclamation state of the respective given portion of storage in the reclamation target.

Following step 1030, the flowchart proceeds to step 1034 which inquires whether additional portions of storage exist to be evaluated per step 1024. A “YES” response returns to step 1024 and a “NO” response proceeds to step 1042. Applying these steps to table 400 of FIG. 4 results in the evaluation of all portions of storage in the PiT volume, e.g., portions of storage 1 through N, because at least one portion of storage in the PiT volume received an access command. Portion of storage 1, having received an access command per column J thus needs synchronization per column F of substantive data and reclamation state, even though the reclamation state and API state are both listed as “used.” With portion of storage 3 having received an access command per column J, it thus needs a synchronization per column F of substantive data and reclamation state, where the reclamation state is changed from the previous reclamation state of “unused” per column E to an updated reclamation state of “used” after synchronization in column G.

In step 1040, which arose because step 1020 determined that no access command was sent to the PiT volume, the reclamation state of “unused” is maintained for each of the at least one portion of storage in the list. This is because no changes occurred to the state or the content of any portion of storage in the PiT volume, and thus the reclamation target would have a consistent states and content with the PiT volume. Additionally, synchronization is not required between the PiT volume and the reclamation target because the states and contents of both volumes are the same. Step 1040 does not apply to the examples in table 400 because an access command was given to the PiT volume.

Following both steps 1040, and a “NO” response to step 1034 confirming synchronization is complete, the PiT volume is deleted in step 1042. Step 1042 is illustrated in FIG. 3D which shows the PiT volume no longer exists. Step 1044 reclaims portions of storage in the reclamation target with a reclamation state after synchronization of “unused.” reclaiming data storage of at least one portion of data in the reclamation target having a reclamation state of “unused” per table 400 of FIG. 4, only portion of storage 4 is reclaimed per column H, which results in a thin volume with reclaimed storage (302D) as shown in FIG. 3D. However, in another embodiment, the process of reclaiming storage may result in no portions of data being reclaimed, e.g., in the case where all slated portions of storage were accessed during the reclamation process, and thus have a state of “used.” In summary for example cases listed in table 400, of all the portions of storage 1 to N of the reclamation target, only one portion of storage was reclaimed. And if only four portions of storage existed in the reclamation target, e.g., N=0, then the one reclaimed portion of storage, portion 4, would represent a 25% reduction of the allocated storage, while guaranteeing no loss of data during the reclamation process. Thus the present disclosure provides a method, apparatus, and system of reclaiming storage in an unsynchronized file system while guaranteeing no loss of data.

Although the present embodiments have been described with reference to specific example embodiments, it will be evident that various modifications and changes may be made to these embodiments without departing from the broader spirit and scope of the various embodiments. For example, the various devices, servers, switches, memory, storage devices, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated ASIC circuitry, programmable gate arrays, and other circuits). Also, the reclamation of storage could be used in systems, networks, or devices of any basis, e.g., having an electronic, optical, or other method or hardware of transmitting or processing data.

In addition, it will be appreciated that the various operations, processes, and methods disclosed herein may be embodied in a machine readable medium and/or a machine accessible medium compatible with a data processing system (e.g., a computer system), and may be performed in different permutations, or sequences. Accordingly, the specification and drawings are to be regarded in an illustrative rather than a restrictive sense.

What is claimed is:

1. A method of reclaiming data storage in a storage device slated as a reclamation target, the method comprising:
redirecting write commands intended for the reclamation target located on the storage device to a point-in-time volume of the reclamation target;
generating a list of at least one portion of storage from the reclamation target, wherein each of the at least one portion of storage has an application programming interface (API) state of unused per a system that uses the storage device;
converting a reclamation state associated with each of the at least one portion of storage from the list to an unused state; and
synchronizing the point-in-time volume with the reclamation target to capture any changes in the point-in-time volume.

2. The method of claim 1 further comprising:
communicating the list of at least one portion of storage to the storage device; and
maintaining the reclamation state of unused for a given portion of storage in the list if a respective given portion of storage in the PiT volume does not receive an access command.

3. The method of claim 1 further comprising:
maintaining a reclamation state of unused for each of the at least one portion of storage in the list if no access command is given to the point-in-time volume during the method of reclaiming data storage.

4. The method of claim 1 wherein synchronizing the point-in-time volume to the reclamation target further comprises:
canceling a reclamation of a given portion of storage in the reclamation target, if an access command was directed to the given portion of storage in the point-in-time volume;
converting the reclamation state of the given portion in the reclamation target to a used state; and
copying substantive data from the given portion of storage in the point-in-time volume to a respective portion of storage in the reclamation target.

5. The method of claim 1, wherein
converting can be performed by the storage device and wherein converting appears as an atomic operation to a host electronic device utilizing the storage device.

6. The method of claim 1, wherein an API state associated with a given portion of storage supersedes a reclamation state of the given portion of storage during converting.

7. The method of claim 1 further comprising:
creating a point-in-time volume of the reclamation target.

8. The method of claim 1 further comprising:
deleting the point-in-time volume after completing synchronizing.

9. The method of claim 1 wherein
the reclamation target is a thin volume,
wherein the portion of storage is a chunk of storage, and
wherein the access command is an item selected from a group consisting of: a read command, a write command, and a read and write command.

10. The method of claim 1 wherein
the method is implemented on an item selected from a group consisting of: a storage device, a host system, and an intermediate switching device, any of which can use any point-in-time protocol.

11. The method of claim 1 further comprising:
reclaiming data storage of at least one portion of storage in the reclamation target having a reclamation state of unused following synchronization.

12. The method of claim 1 wherein
the storage device is an item selected from a group consisting of: an on-die cache, a local memory, an external storage, a network attached storage, and a remote storage device.

13. The method of claim 1 wherein
the at least one portion of storage only has two possible states of used and unused.

14. A method of reclaiming data storage in a storage device slated as a reclamation target, the method comprising:
redirecting, write commands intended for the reclamation target to a point-in-time volume of the reclamation target;
generating a list of at least one portion of storage that has a state of unused per a system that uses the storage device;
converting a reclamation state of each of the at least one portion of storage from the list to an unused state; and
maintaining a reclamation state of unused for each of the at least one portion of storage, if no access command is redirected to the point-in-time volume during the method of reclaiming data storage.

15. The method of claim 14 wherein synchronization is not required between the point-in-time volume and the reclamation target if no access command is redirected to the point-in-time volume.

16. The method of claim 14 further comprising:
creating the point-in-time volume of the reclamation target; and
deleting the point-in-time volume after the converting.

17. A device comprising:
a local memory;
a local processor coupled to the local memory; and
wherein the local processor and local memory execute instructions for a method of reclaiming data storage in a storage device slated as a reclamation target, the method comprising:
redirecting write commands intended for the reclamation target located on the storage device to a point-in-time volume of the reclamation target;
generating a list of at least one portion of storage from the reclamation target, wherein each of the at least one portion of storage has an API state of unused per a system that uses the storage device;
converting a reclamation state associated with each of the at least one portion of storage from the list to an unused state; and
synchronizing the point-in-time volume with the reclamation target to capture any changes in the point-in-time volume.

18. The device of claim 17 wherein the method executed on the local memory and process further comprises:
communicating the list to the storage device;
repeating the converting for each of the at least one portion of storage in the list; and
maintaining the reclamation state of unused for a given portion of storage that does not receive an access command.

19. The device of claim 17 wherein the instructions for the method are stored on a computer readable medium.

20. A system comprising:
a storage device having a local memory coupled to a local processor;
a host electronic device coupled to the storage device; and
wherein the host electronic device and the storage device will execute instructions for a method of reclaiming data storage in a storage device slated as a reclamation target, the method comprising:
redirecting write commands intended for the reclamation target located on the storage device to a point-in-time volume of the reclamation target;
generating a list of at least one portion of storage from the reclamation target, wherein each of the at least one portion of storage has an API state of unused per a system that uses the storage device;
converting a reclamation state associated with each of the at least one portion of storage from the list to an unused state; and
synchronizing the point-in-time volume with the reclamation target to capture any changes in the point-in-time volume.

21. The system of claim 20 wherein the method executed on the local memory and process further comprises:
communicating the list to the storage device;
repeating the converting for each of the at least one portion of storage in the list; and
maintaining the reclamation state of unused for a given portion of storage that does not receive an access command.
